(19) United States
(12) Patent Application Publication
(10) Pub. No.: US 2006/0252021 A1
(43) Pub. Date: Nov. 9, 2006

(54) Requirements based registration system

(76) Inventors: Harold C. Watkins, Portsmouth, VA (US); Anthony L. Watkins, Portsmouth, VA (US)

Correspondence Address: SETO PATENTS, 406 RIVERLAND DR., SALEM, VA, 24153, US

(21) Appl. No.: 11/120,283

(22) Filed: May 3, 2005

(51) Int. Cl. G09B 3/00

(52) U.S. Cl. 434/350

(57) ABSTRACT

A requirements based registration system for higher education that decreases students' time-to-degree and credits-to-degree by optimizing the registration process. After students log into the system, they are presented their student profile and degree progression information. Once that information is verified, the system displays the students' available remaining requirements to obtain their desired degree. After students specify the requirement(s) to be satisfied, the system generates fulfillment options that ensure each course selected does in fact satisfy the specified requirement(s). Upon submission of courses, the system verifies that the student is eligible to enroll in each course and also checks if any course can be used in a more restrictive requirement. The system can prevent students from registering for non-degree (ND) courses or allow a set number of ND courses, based on each student's individual profile (e.g., classification). Students must designate the reason for taking ND courses. The system automatically sets special review flags for first-time freshmen, new transfers, and students changing majors to ensure that due diligent efforts have been performed (e.g., review of transfer equivalencies) prior to registration.

### BACKGROUND OF THE INVENTION

The present invention relates generally to the field of higher education and more specifically to a college course registration system that is able to ensure all degree-seeking students enroll in courses that satisfy outstanding degree requirements.

Four-year colleges and universities offer bachelors degrees that can be obtained in four years, if all prescribed classes are taken within the four year period. The problem however is that typically over 50% of incoming freshman do not graduate in four years. One of the main reasons for not graduating in four years is that students often times register for and take classes that do not count toward their desired degree, even though at the time of registration the students think the class will count toward their degree.

There have been a number of national studies as well as state studies over the past 17 years, prompted by concerns over low graduation rates, increased time-to-degree, and excessive number of credits earned by students. These studies have revealed student-related factors, external factors, and institutional factors. Various corrective strategies have been put forth, such as four-year graduation guarantees, improved academic advising, financial incentives for students to remain full-time, etc. Nevertheless, graduation rates and time-to/credits-to-degree (GR/TCD) have not improved and, in some instances, have worsened.

Throughout Applicants' 15 years in higher education, we have participated in and witnessed processes directly impacting registration, persistence, graduation, and time-to/credits-to-degree. Our vantage-point is our grass roots involvement with students, faculty, staff, and the administration. We have actively participated in hundreds of faculty meetings that addressed issues of advising and clarification of degree requirements. For a period of five years, we had direct responsibility for degree clearance at a four-year degree granting institution. We have also been involved in degree clearance processes at several other institutions of higher education. We have seen first-hand situations in which students took courses just to be full-time, because courses they needed were not available. We have been involved with issues of transfer credit at both the policy and the implementation levels. Over the last several years, we have documented over a thousand instances of course mis-registration, prior to the end of the schedule adjustment period.

Through this experience and our research into the problems prevalent in higher education, we recognized that a major shortcoming was the complete absence of a system to implement and enforce the higher education policies and strategies formulated to improve graduation rates, degree completions, and time-to/credits-to-degree at the point of registration. Most states have adopted a statewide transfer policy, but no safeguard is available to prevent a student from mis-registering for a requirement that can be met by a transfer course. An Alabama study considered increasing financial aid to traditional full-time students. While this policy may or may not increase graduation rates, it may over time result in less aid to part-time students, many of whom are economically disadvantaged. Institutions can encourage better advising, but not all faculty members are good advisors and some do not see their role as being responsible for student graduation.

A study done by the California State University Task Force on Facilitating Graduation indicated that in the early 1990s, there was considerable concern nationally after a report from the National Center for Education Statistics (NCES) revealed that the percentage of students graduating in four years or less had declined to 31.1 percent in 1990 from 45.4 percent in 1977. The year 2000 annual report published by ACT, Inc. states that the five-year graduation rate was 41.9 percent at public institutions versus 55.5 percent at private institutions. These graduation rates were the lowest since 1983, when ACT first began tracking these statistics. A report from Illinois' Shared Enrollment and Graduation Information System states that only 26 percent of students in the 1987 to 1992 public university freshman classes graduated in four years. After five years, 48 percent had graduated, and 56 percent had graduated by the end of six years. According to a 1996 report by the Texas Higher Education Coordinating Board, fewer than 30 percent of Texas students who earn baccalaureate degrees, do so in four years.

In response to a 1996 resolution by the General Assembly of Maryland, the Maryland Higher Education Commission (MHEC) studied the amount of time it takes to earn a degree at Maryland colleges. MHEC reported that of the 1989 full-time freshman only 24.5% graduated in four years; 50.4% graduated in five years; and, 58.2% graduated in six years. The percentages were even lower for transfer students.

Graduates are taking longer to complete their degrees and completing far more credits than needed for their degree. Consider that the majority of baccalaureate programs have suggested sequences that result in completion in 4 years (8 semesters) and require 120 credit hours. This is in stark contrast to the reality of higher education in America. On average, 1998 Illinois public university graduates enrolled in about 12 terms before graduating. Moreover, students who received baccalaureate degrees in Texas public universities during fiscal year 1995 spent an average of six years completing their degree requirements, were enrolled for 13.9 semesters, and attempted 154.7 semester credit hours of course work. These extended graduation times and excessive credits not only cost the students and their parents, but it also places a financial burden on the institution and state as well. Texas approximated the cost of education for their students and the state based on the number of years before students receive a baccalaureate-level degree. Their findings indicate that the cost to the parent and/or student increase approximately $10,000 each year after four years. The cost to the State increase approximately $4,000 each year after four years.

The University of Minnesota addressed head-on the issues that extended degree time has on institutional resources. They noted:
“Many people reason that because students still need to take the same classes, whether for four years or seven, the cost to the institution is the same. But in fact, a student who is taking 12 credits a semester often uses as many university resources, other than classes, as a student who is taking 16 credits. That student still meets with an advisor, talks to a librarian, needs study space, participates in intramural sports, talks to a financial aid counselor, goes to the writing lab, uses e-mail, and registers for classes. Although the cost of each transaction may be small, the aggregate costs to the institution of providing good service are significant.”

Graduation rates, degree completions and time-to/credit-to-degree present significant and persistent problems across the nation. Studies in the states of Alabama, California, Illinois, Maryland, Ohio, Pennsylvania, Texas, and Wisconsin have consistently identified a number of factors that impact on graduation rates and time-to/credits-to-degree (GR/TCD). Some studies have categorized these factors as: 1) external factors, 2) student factors, and 3) institution factors. This categorization is helpful because it allows the state and the institution to focus on those factors that they can reasonably influence. However, it must be recognized that some “student” factors may be caused or influenced by institution action or inaction.

External Factors: Factors such as family, marital and health issues, and financial status of family are regarded as external factors, over which the student may not have primary control. Given the concerns of policy makers over the cost of higher education, the likelihood for drastically increased financial aid for needy students is not great. Institutions will have to look elsewhere for improvements in GR/TCD.

Student Factors: There are a number of student factors impacting GR/TCD, including but not necessarily limited to:
1. Stopping or dropping out of college.
2. Taking a reduced course load.
3. Attempting an excessive number of courses (personal enjoyment, poor college preparation, changing majors, transferring, mis-registration)

Institution Factors: Several institution factors impacting graduation rates and time-to/credits-to-degree have been identified, including but not necessarily limited to:
1. Degree programs that require an excessive number of credits
2. Unavailability of courses needed for graduation
3. Problems with the acceptance of transfer credits
4. Liberal course add/drop policies
5. Full-time policies (e.g., defining full-time as only 12 hours)
6. Poor quality of advising and confusing degree requirements.

Over the course of the past 17 years, a number of state-initiated and institutional studies have considered or recommended policies and strategies to improve graduation rates and time-to/credits-to-degree. We place these recommendations into one of two categories:

1. General Strategy

2. Accountability Measure

A general strategy and an accountability measure both address the “how.” If the “how” is concrete, discrete, results-oriented, and easily verifiable, then it is an accountability measure. Otherwise, it is a general strategy. Improving academic advising through the use of an experienced advisor is a general strategy; implementing a four-year graduation guarantee is an accountability measure. It is our position that none of these strategies or accountability measures directly addresses the key issue, which is ensuring students do not take unnecessary courses.

Further, it is our position that these strategies and accountability measures do not have an implementation mechanism. For example, an institution can prescribe that a student transferring in 9 hours of humanities is deemed to have met the general education humanities requirement, even if the major designates a specific course. But this transfer policy has no implementation component, and it is therefore likely that a significant number of transfer students will unnecessarily take the humanities courses.

The University of Washington notes that oversubscribed courses are a barrier to academic progress and when students experience delays enrolling in courses, they accumulate credits in areas unrelated to their fields of interest. Illinois and Alabama both note that institutions can improve time-to-degree by increasing the availability in courses. Students in Maryland taking longer than 4 years to graduate stated the unavailability of courses and infrequency of upper-level course offerings have required them to extend their times-to-degree.

In 1993, we attended a statewide Transfer Articulation workshop for institutions of higher education, sponsored by the State Council of Higher Education in Virginia (SCHEV). The purpose of this workshop was to stress that higher education in Virginia was a system consisting of both two-year and four-year colleges. Students should be able to move seamlessly within this system. Four-year colleges were expected to accept general education and major (where appropriate) courses that students transferred in from two-year colleges. On Oct. 1, 2004 SCHEV issued a policy paper, entitled “State Policy on College Transfer.” That report read, in part:
“The State Policy on Transfer aims to enhance cooperation and consistency among institutions of higher education in Virginia with the intended goal of improving transfer for Virginia's students. This goal of smooth and orderly transfer has not been fully achieved, even though a number of community colleges and senior institutions have worked together diligently.”

The University System of Maryland has a statewide transfer articulation system called “ArtSys” that provides course equivalencies for many courses transferred in to four-year colleges from two-year colleges. Further, some institutions have transfer policies that extend beyond simple course equivalencies. The problem is that there are no implementation mechanisms at the point of course registration. Students frequently enrolled in courses to satisfy a requirement that can be met through transfer equivalency or through application of a transfer policy. In state studies that included student feedback, the problems of poor advising and confusing degree requirements were often cited. MHEC reported:
“Problems associated with faculty members included: unavailability of faculty, lack of enthusiasm for advising, and unfamiliarity with degree or professional requirements. The outcome was inappropriate classes, classes that did not count toward the degree, or the selection of courses based on poor academic advice.”

Colleges have debated whether advising should be centralized (primarily staff), particularly for freshman and students who have not declared a major or decentralized (primarily faculty). Various states have recommended strongly that students be given an experienced advisor. To address GR/TCD, some institutions believe that advisors should be proactive in encouraging students to not only continue their enrollment uninterrupted, but to take a sufficient number of courses each semester to graduate within four years. Further, these advisors should discourage students from withdrawing from courses, which with a little more effort, the student could successfully complete.

Good academic advising, whether by faculty or staff, should have a significant impact on GR/TCD. However, good academic advising is focusing on the personalized aspects, not the mechanics of registration and degree fulfillment. Advisors should work with students on exploring their interest and selection of a major, and within a major, a specific concentration.

A computer program is a sequence of instructions that can be executed by a computer. The term program can refer to the original source code or to the executable (machine language) version. The term also implies a degree of completeness; that is, a source code program comprises all statements and files necessary for complete interpretation or compilation, and an executable program can be loaded into a given environment and executed independently of other programs. A computer programming language is an artificial language used to write a sequence of instructions (a computer program) that can be run by a computer. Similar to natural languages, programming languages have a vocabulary, grammar, and syntax. However, the languages used to program computers must have simple logical structures, and the rules for their grammar, spelling, and punctuation must be precise. Programming languages vary greatly in their sophistication and in their degree of versatility. Some programming languages are written to address a particular kind of computing problem or for use on a particular model of computer system. For instance, programming languages such as FORTRAN and COBOL were written to solve certain general types of programming problems—FORTRAN for scientific applications, and COBOL for business applications. Although these languages were designed to address specific categories of computer problems, they are highly portable, meaning that they may be used to program many types of computers. The most commonly used programming languages can be used to effectively solve diverse types of computing problems and include C, JAVA, SQL, and VISUAL BASIC.

Low-level programming languages, or machine languages, are the most basic type of programming languages and can be understood directly by a computer. In machine languages, instructions are written as sequences of 1s and 0s, called bits, that a computer can understand directly. Any single bit can be used as a “flag” in programming. Flags are used to answer simple “yes or no” type questions, with a one in the designated bit representing a “yes” answer and a zero representing a “no” answer.

What is needed in the field is a system safeguard that prevents course mis-registrations and implements and enforces other policies and strategies adopted by institutions to address issues of student graduation rates. Out of ten strategies that the Texas Coordinating Board devised, limiting enrollment to required courses was given the highest rating in each of the three categories meant to gauge effectiveness: 1) Effectiveness in Reducing Time-to-degree, 2) Potential for Cost Savings to State, and 3) Potential for Cost Savings to Parents and Students (see chart). However, it was given the lowest rating in each category of how likely it could be implemented: 1) Ease of Implementation and 2) Feasibility. In other words, the Board determined this strategy would be the most effective in reducing student's time-to-degree, but was the hardest to implement. In regards to the fiscal impact, the Texas Board said “If it was somehow possible to limit students to three or some small number of courses beyond those required for the major, there would be dramatic savings to both the state and students . . . Institutions would be required to maintain much more sophisticated student tracking systems . . . Significantly more staff effort would be required for student advising and processing changes of major.” The present invention makes this strategy feasible and extremely straightforward to implement. Furthermore, because the present invention is a system solution, it requires little to no additional staff effort.

### SUMMARY OF THE INVENTION

An automated requirements based registration system with multiple software modules, each module containing routines and sub-routines designed to be executed on one or more computers. The registration system is adapted for use by a degree granting institution for decreasing time-to-degree and credits-to-degree by students of the institution by optimizing the registration process that is regularly performed by the students prior to each term of the institution.

A registration module is used to gather and verify information about the students' profile, to show students their unique outstanding requirements for degree progression and generate fulfillment options for the requirements the students desire to complete. The registration module also verifies the student course section selections, notifies the student of any errors, and completes enrollment.

A non-degree module that is in communication with the registration module provides information to the registration module and to the students on courses that do not count toward a desired degree. The non-degree module can be set to allow a student to register for a limited number of courses for personal enrichment, which are not required by the student's selected degree.

A special registration module that is also in communication with the registration module, is accessed by a staff member of the institution and allows the staff member to register the students for courses that otherwise would not be allowed by the requirements based registration system.

A withdrawal module, also in communication with the registration module, provides information to the registration module and the students regarding courses from which the students have withdrawn and are considering withdrawing.

An interface module, which is in communication with the registration module, provides the students with a user interface that enables the students to perform the registration process in a manner that ensures each students' desired degree will be achieved in a shortest amount of time and by taking a smallest number of courses. The registration module includes a student profile module that gathers, verifies, stores and displays information about the students, including information about the students' progression toward their desired degree. The registration module also includes administration flags that are used to indicate that the students have been admitted for an upcoming term and are not on academic or financial suspension. Multiple special flags are used to indicate first time students, change of major students and transfer students.

The registration module also includes a fulfillment options module that contains information on the requirements for each degree that is offered by the institution. The requirements for each degree includes a list of all courses that must be taken and a list of courses that may optionally be taken. The fulfillment options module is capable of generating one or more potential course-loads for the students that ensures each students' desired degree will be achieved in a shortest amount of time and by taking a smallest number of courses.

The registration module further comprises, a course sections module, that checks to make sure specific sections of courses that the students attempt to register for are actually available and, a verification module, that provides verification to the students at the end of the registration process regarding which courses the students have successfully registered for and notification to students regarding which courses failed verification.

A course check module checks for the existence of desired course sections, duplication of courses, credits exceeded, fulfillment of degree requirements, pre-requisite and co-requisite fulfillment, timing conflicts, availability of courses, and degree requirement priority.

It is an object of the present invention to decrease the average time it takes for students to graduate from a degree granting institution.

It is another object of the present invention to allow students to graduate from a degree granting institution with the fewest possible number of credit hours.

It is yet another object of the invention to allow the students to see which requirements they still need to fulfill in order to graduate and the courses that are being offered by the institution during the upcoming term that the student is eligible to take, which can satisfy these requirements.

### BRIEF DESCRIPTION OF THE DRAWINGS

The invention of the present application will now be described in more detail with reference to the accompanying drawings, given only by way of example, in which:

FIG. 1 is a high-level flow chart of a portion of the preferred embodiment;

FIG. 2 is a mid-level flow chart of the preferred embodiment;

FIG. 3 is a flow chart of the course check module;

FIG. 4 is a flow chart of the “not applicable to degree” (NAD) module;

FIG. 5 is a flow chart of the NAD course check routine;

FIG. 6 is a flow chart of the special registration module;

FIG. 7 is a flow chart of the special registration checks routine;

FIG. 8 is a flow chart of the withdrawal module; and,

FIG. 9 is a flow chart of the withdrawal checks routine.

### DETAILED DESCRIPTION OF THE INVENTION

Requirement-Based Registration (RBR) is a “systems” innovation, which guarantees that all courses students enroll in will be used toward the successful completion of their designated degree program. RBR is able to provide this guarantee by not allowing students to register directly for any course, e.g., PHIL (philosophy) 101. Students must first specify the degree requirement that they are attempting to fulfill (e.g.—social science, 2^{nd} natural science, etc). Once the student specifies the degree requirement, RBR restricts registration to only those courses that will in fact meet the requirement.

RBR effectively performs degree audit at the point of registration, based on each student's individual record. A student's record comprises 1) an administrative flag, 2) profile, 3) a special review flag, and 4) degree progression parameters. The administrative flag is enabled if the student has been admitted for the term and the student is not on academic, financial, or judicial suspension or dismissal. The profile includes major, concentration, track, minor, classification, admit type, term entered, applicable catalog, placement test scores, SATs, high school GPA, transfer courses, transfer GPA, previously completed courses, college GPA, substituted courses, waived requirements, current classes, total number of unrelated courses, and the total number of withdrawals.

There are two types of special review flags: accountability and general. There are three accountability flags, which are built into RBR, one each for first-time students, transfer students, and change of major students, in the preferred embodiment. In operation, a new transfer student is not allowed to register until the special review flag (automatically set within RBR) is turned off by both the transfer articulation office and the advising office. By turning the flag off, the transfer articulation office is certifying that a diligent effort has been made to enter and articulate all transfer courses. The advising office is certifying that it has reviewed and concurs with the student's transfer courses and articulation. General review flags provide flexibility to the institution for various offices to deal with special groups of students. These flags include veterans, athletes, honors, international students, special admits, special program, student records, financial aid, student accounts, academic standing, and academic department. For instance, veterans may be required to sign a form prior to registration. The veteran's flag, controlled by the Veterans Office, enforces this requirement.

Degree progression parameters include 1) the minimum and the maximum number of term enrollment hours allowed, 2) the maximum number of unrelated courses allowed, and 3) the maximum number of withdrawals allowed. These parameters will effectively enforce various policies and strategies formulated by state commissions of higher education and individual institutions to address graduation and persistence problems.

When students login to and are cleared to register under RBR, a number of batch as well as real time algorithms have been/are run to determine the following:

1. Requirements that have been met. RBR does not allow students to register for requirements that have been met. For example, a college's transfer policy may specify that students who transfer in nine hours of humanities will be deemed to have met the college humanities requirement even if the student's major has designated a specific humanities course (e.g.—PHIL 201). An advisor who is unaware of the transfer policy may advise a transfer student (with nine hours of humanities, not including philosophy) to take PHIL 201. However, RBR determines that this student's humanities requirement has been met (per the college's transfer policy) and does not provide this student the opportunity to mis-register for PHIL 201.

2. Requirements that have not been met, but are not available during the current registration period. RBR does not allow students to register for these requirements. For example, to ensure that students follow their catalog, a college may specify that freshman students may not register for requirements suggested in the students' junior and senior years, per the applicable catalog. Other unavailable requirements would include:
Requirement pre-requisite not met (typically when the course and the requirement are one and the same).
Requirement not offered during the current semester, e.g., spring course and registration is for the fall semester (typically when the course and the requirement are one and the same); and,

3. Requirements that have not been met and that are available. Students can register for these and only these requirements, subject to normal registration policies, (e.g.—maximum number of credits). RBR presents the requirements to the students as they are listed in the catalog (e.g.—Computer Science Breadth, 2^{nd} Natural Science). Once a student selects a degree requirement, RBR ensures that students can only register for courses that fulfill the selected requirement.

By not allowing course mis-registration, RBR can implement and enforce most of the strategies and accountability measures referenced in this report, thereby directly impacting graduation rates, degree completions, and time-to-/credits-to-degree.

Reduce Number of Credits Required

There is a trend toward establishing 120 credits as the required number of credits for graduation, unless there is a bona-fide exception (e.g.—accreditation standards)

Clearly reducing the degree requirement in an academic program from 130 to 120 hours should have a significant impact on GR/TCD. The action, however, does not prevent students from taking extra courses for personal enjoyment and does not prevent mis-registration; RBR accomplishes both of these tasks.

While RBR cannot ensure that an advisor properly counsels his/her advisees, RBR can absolutely ensure that students do not register for courses that will not be used towards their degree. Many institutions note that proper academic advising will not completely solve the problem. A year 2000 Illinois study found that students commonly blame their predicaments on poor advising, but noted that when the University of Illinois at Chicago College of Engineering began requiring students to sign advisory agreements, the students did not follow the agreement. The study also noted that staff and faculty take for granted that students will do the cursory checks in the course catalog for pre-requisites or enroll in courses recommended by the advisors, but they often do not. RBR would enforce these advisory agreements by ensuring students take the appropriate courses based on their degree and individual student record. RBR ensures that students' courses will meet their requirements without sacrificing the other key issues pertaining to timely graduation.

RBR directly addresses many of the factors impacting graduation rates, degree completions, and time-to/credits-to-degree, the most important of which is the excessive number of credits not counting toward graduation. Three causes are listed below:

1. Students take courses for eniovment. RBR gives each institution the option to not allow courses outside a student's degree program. An institution may also elect to set a limit on the number of unrelated courses allowed.

2. Students mis-register (student/advisor error or confusing degree requirements). RBR does not allow course mis-registration, even if the student is advised by faculty to take the course. Degree requirements are exactly identical to requirements imposed at degree clearance time; under RBR these requirements are necessarily definitive.

3. Change of decree program (students transfer in and native students change majors). Almost one in every two college students has transferred one or more times. Most states have adopted state-wide transfer policies intended to ensure a smooth transition for transfer students and the maximum acceptance of previously completed transfer courses. These policies are heavily dependent upon faculty and staff actions, at the most hectic period in higher education—registration. Much falls between the cracks. RBR's special review flags (transfer student and change of major students) places accountability on the offices responsible for transfer articulation and advising, to certify that they have done a diligent job in reviewing courses previously completed outside the current degree program. The first-time student review flags places accountability on the office advising first-time students that there has been a diligent effort to understand the student's personal goals and interests, and that the student has been counseled as to the various degree options offered by the institution.

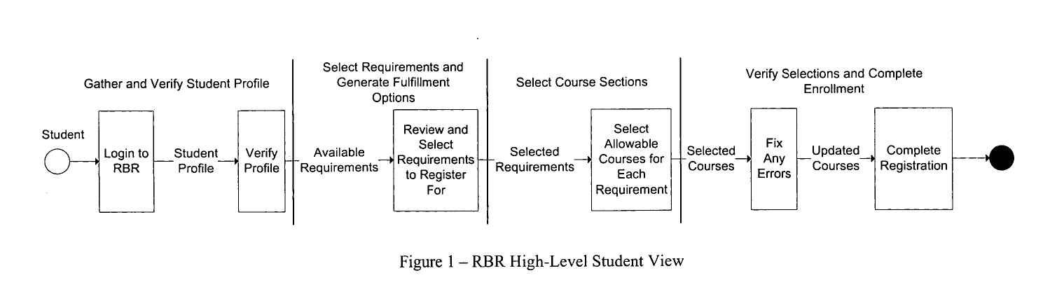

RBR is achieved in a four-phase process. These phases are 1) gather and verify student profile, 2) select requirements and generate fulfillment options, 3) select course sections, and 4) verify selections and complete enrollment. On a high level, the student takes the actions illustrated in FIG. 1. In Phase One, the student logs into RBR and verifies their student profile information (i.e.—curriculum, catalog, classification, and special programs) as stored in the system. In Phase Two, the student reviews and selects unfulfilled requirements to register for. In Phase Three, the student selects allowable courses to fulfill their selected requirements. In Phase Four, the student fixes any errors that occurred and finally completes their enrollment.

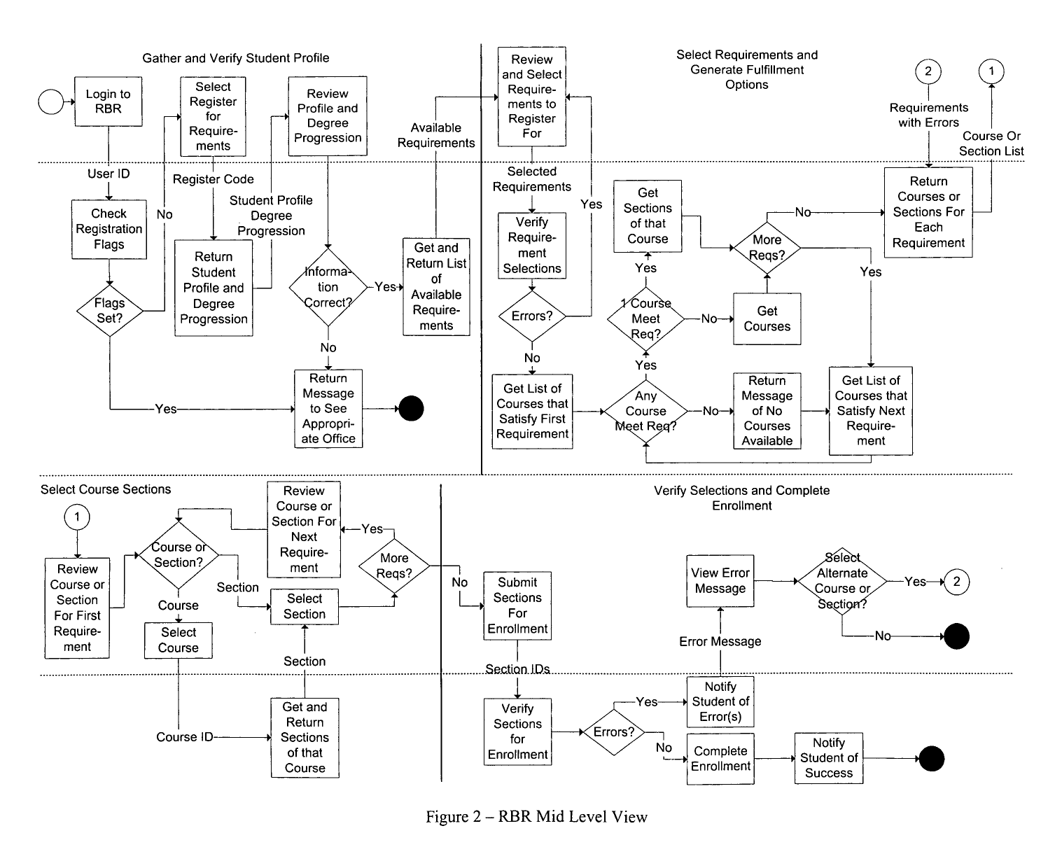

From a student's perspective, RBR is not complicated (nor should it be). However, RBR involves a great deal of system processing and requires that certain tasks be performed to ensure that it can guarantee students only take courses that will meet their unique requirements. We will now take an in-depth look at the interaction between the student and system in each phase of RBR during registration (see FIG. 2) and further breakdown some of the more critical tasks the system performs.

FIG. 2

Phase 1: Gather and Verify Student Profile

The student begins this phase by logging in to the RBR system. RBR first checks Registration flags for the student to ensure that he/she is eligible to register. The system then validates the student's login information and retrieves their student record. When the student selects Register for Requirements, the system returns their degree progression requirements and information within their student profile to them. If all of the student profile information is correct and the student acknowledges their degree progression requirements (if any), the system will gather and return the list of remaining and available requirements to the student. However, if the student determines that any of the information in their profile is incorrect; he/she is instructed to see their advisor or department to have the errors corrected prior to registration.

Providing a student with a list of remaining and available requirements is a complicated process. As mentioned earlier, a student's profile (unique to an individual student) is used to determine their remaining requirements. Their profile information includes such information as their curriculum, catalog, classification level, and special programs. Moreover, the system must also store and ensure accurate data on the course catalog, programs, current courses, and student records. Each of these can be a daunting task.

There are several key elements of RBR that must be in-place before a student can register for requirements. They are as follows:
1. Catalog Verification with University Practice
2. Accurate Record of Current Courses
3. Accurate Student Records—Curriculum
4. Accurate Student Records—Catalog
5. Accurate Student Records—Classification Level
6. Accurate Student Records—Special Programs and Students
7. Accurate Student Records—Test Scores
8. Accurate Student Records—Transfer Courses
9. Accurate Student Records—Change of Major
10. Accurate Student Records—Entering “Folder” Substitutions
   1. Catalog Verification with University Practice

The course catalog is the initial source of programs, requirements, and courses that fulfill the listed requirements. This information is entered electronically into the Requirements Based Manifest (RBM). The RBM details for all active curriculums 1) each requirement of the curriculum, 2) the minimum grade required for each requirement, and 3) the course(s) that can fulfill each requirement. Catalogs lack the “absolute” accuracy necessary for the RBM and therefore only serve as a starting point for its development. The catalogs are often incorrect or rather incomplete for several reasons: 1) common courses that are not listed in the catalog as satisfying a requirement are often taken to satisfy that requirement; 2) some courses are listed but never offered; and 3) new courses are offered after the time the catalog was published. Furthermore, new requirements may be added to curriculums due to mandates by accrediting agencies or for student certifications.

Due to these inaccuracies and omissions that are commonplace in the higher education field, it is necessary to meet directly with the registrar's office and various departments to discuss the current state of the programs the school offers. This step involves taking a comprehensive look at the programs with several school officials. The catalog is shown to registrar's office and department officials as it was entered electronically into the RBM. The RBM must be verified with each of them to ensure that all inaccuracies and omissions associated with all active catalogs are captured. This verification process includes an expanding or decreasing list of courses that will satisfy a requirement, incorrect or incomplete listings of requirements being corrected, courses that are never offered being taken off the manifest, and new concentrations or minor options not listed in the catalog being added. This verification process is iterative, that is once the changes are made to the system the new RBM is resubmitted to the university to ensure correctness. Any changes that were entered incorrectly or any inaccuracies with the course catalog that were not caught by the previous round will be corrected.

2. Accurate Record of Current Courses

It is also necessary to ensure that the system maintains an accurate record of currently offered courses (for the period being registered for). When finding or verifying the courses that will satisfy a requirement, the system must ensure the course is being offered and that it will satisfy the requirement. In that regard, it is essential that the courses currently being offered are matched exactly to the courses that are listed in the RBM. Recall that the RBM was derived from the course catalog and verification process with the registrar's office and department officials. The RBM list all requirements for all programs offered by the school and the courses that satisfy those requirements. If the course the student desires to take for a requirement is not matched to the identical course in the RBM the student will 1) not be allowed to register for a course that truly does satisfy the requirement or 2) be allowed to register for a course that does not satisfy the requirement. Both of these situations are unacceptable for a requirements based registration system.

Due to the absolute need for an accurate RBM, the RBM is validated against extensive empirical testing with three groups of students. First, we apply the RBM to the last year's graduating class and determine if any students graduated with missing requirements per the RBM; we then determine with the university which courses not on the RBM were used to meet the missing requirements, and whether the substitutions were case-by-case or routine. Routine substitutions are added to the RBM. Second, we apply the RBM to applicants for graduation during the last year who were determined to be ineligible. We want to identify any inconsistencies in the application of university policy and practices. For the third group, we run the RBM against currently enrolled students who have unused courses per the RBM. We look for patterns, e.g., a number of math majors taking the same unused course. We want to verify with the university that the RBM is complete based on both policy and general practice.

3. Accurate Student Records—Curriculum

The student's curriculum is vital for determining a student's requirements. The curriculum is composed of the student's major and can include an additional major, minor, track, or concentration. Students in the same major may have different concentrations or minors that will affect their requirements. For example, the requirements of a business major with a concentration in accounting may vary greatly from a business major with a concentration in marketing. For this reason, it is critical that the office responsible for record-keeping properly records not only the student's major, but the student's concentration, track, minor, etc.

Because of the high degree of incomplete records, the university can select one of two options. Option one is the RBR contains an “optimal curriculum” algorithm. This algorithm can determine within any major, the optimal curriculum for a student (based on courses completed, current courses, and pre-registered courses) in terms of least credits to degree. The second option is to use a core curriculum that includes only requirements that are common to all concentrations and tracks within the major. Students will not be able to register for major requirements outside the core courses until a specific concentration or track is declared and entered into the student's record.

4. Accurate Student Records—Catalog

The problems of ensuring that a student follows their correct requirements are further compounded by the catalogs. Institutions usually print their catalogs to cover a span of two to three years. If a student is at the university during a catalog change, they typically have the option of switching to the new catalog. Students are normally enrolled 4 years or more before they graduate, meaning a student will have the option of switching to a new catalog at least once, if not twice, prior to their graduation. The advisor and student must know which catalog governs the student's enrollment or the student may attempt to take requirements that do not apply to them. If the student desires to follow the new catalog, this change must be tracked and the student's record must be revised.

It is important to note that the RBR system makes the determination of the applicable catalog, based on the university's policy in the catalog under which the student entered. Cohort-wide exceptions may be made to comply with accreditation or certification changes. But discretionary and inconsistent determinations by individual advisors are not permitted, with the exception that students can generally opt to follow the new catalog requirements.

5. Accurate Student Records—Classification Level

The classification level stored for every student needs to be correct. A student's classification can affect the courses a student can take to satisfy a requirement or the courses a student must take. For example, some courses require a junior or senior level standing. If the student's classification is not correct and a course uses that as a criterion for enrollment, RBR will not let the student fulfill a requirement with that course.

6. Accurate Student Records—Special Programs and Students

Colleges serve a highly diverse student population and there are a myriad of programs designed to meet unique needs or requirements of each group. Honors students may be required to take the honors sections of designated courses; special admit students may be required to meet with a student success office prior to registration; athletes may be required to meet with a compliance officer prior to registration, etc. RBR can enforce these requirements. However, the information identifying these special students must be properly recorded in, or calculated/derived by, the automated student records system.

7. Accurate Student Records—Test Scores

Students test scores upon entering college will often affect the courses they must take. Students with low test scores may be required to take developmental courses, while students with very high test scores may have a requirement waived altogether. Test scores and their affect on student requirements must be recorded such that RBR can correctly ensure students take the right course based on their individual performance.

8. Accurate Student Records—Transfer Courses

Students often transfer or take courses from other institutions. These transfer courses must be articulated, where possible, for the equivalent university course prior to enrollment. If the course is not equated and mapped to a requirement prior to registration, the student will be allowed to register for a requirement that could have been fulfilled with the transfer course. Some institutions and states have mandated articulation agreements that govern intra-state transfers between institutions. These articulations must be built in to ensure consistent and fair treatment of transfer course substitution.

RBR automatically sets a transfer student flag for all students who are admitted as a new transfer student. A new transfer student can not register until this flag is turned off by 1) the office responsible for entering and equating transfer courses and 2) the office responsible for advising the transfer student. This flag is intended as an accountability measure wherein the responsible offices are certifying that due diligent efforts have been made to properly record transfer courses and review course equivalencies.

9. Accurate Student Records—Change of Major

Students often change majors while in college. Courses they took in their former program may be substituted to meet requirements in their new program, even though the new requirements call for slightly different courses. It is important that these substitutions are made prior to enrollment so that a student does not register for a requirement that can be fulfilled by prior course work.

RBR automatically sets a change of major flag for all students who switched majors since the last registration term. A change of major student can not register until this flag is turned off by 1) the office responsible for clearing general education requirements and 2) the office responsible for clearing major requirements. This flag is intended as an accountability measure wherein the responsible offices are certifying that due diligent efforts have been made to review and substitute, as appropriate, courses previously completed under a different major.

In addition, the university must ensure that the change of major is recorded properly in the system for the student's correct requirements to be computed. For example, if a student came in as a computer science major, but decided to switch to an English major and this change was not made on the student's record, RBR will show the student requirements for a computer science major and not an English major.

10. Accurate Student Records—Entering “Folder” Substitutions

RBR is designed as an institutional accountability system to protect students, parents, and taxpayers by preventing students from taking courses not necessary to earn a degree. At times course substitutions are made and placed in a student's folder within the academic department and/or the registrar's office, without entering the change on the student's automated record. In these instances, RBR will show students requirements that have actually been fulfilled. Finding these and other omissions pertaining to students are very difficult, because no student has the same blueprint to be verified against. However, our system does run several processes and algorithms to capture courses that are not being used towards any requirements for graduation to help identify and alleviate these problems. When we find a pattern of substitutions, we discuss with the university the desirability of adding the course to the RBM as an allowable course. However, it is essential that case-by-case substitutions be duly recorded in the students' automated records.

Methodology:

Maintaining accurate records is only part of the undertaking in providing a requirements-based registration system. There is a great amount of logic and a number of algorithms (or processes) that must be run on the records to create meaningful information on requirements that can be provided to the students, advisors, and departments.

Step 0: Creation of the Initial Courses-Mapped Manifest (CMM)

Step 0 is a precursor to the RBR system. Before RBR begins, the system must have a manifest of all requirements for each student and the courses, if any, that have been mapped to fulfill those requirements. This mapping of courses can be run real-time during RBR; however, it is clearly not advisable because 1) it will create an unnecessary load on the server during the busy registration period and 2) if this information is stored, the college will have a record of outstanding requirements for all active students prior to registration. This information will be crucial in determining which courses and how many seats for those courses should be offered in the upcoming academic year. The CMM is created sequentially as follows:

1. Gather student's profile and course history

2. Run the matching algorithm

Step 1—Gather Student's Profile and Course History; Determines the Optimal Curriculum for the Student

Student Profile. RBR-batch retrieves each student's profile, e.g., major, concentration, classification, term entered, initial catalog, etc. This profile is used to determine the student's curriculum.

Course History. Next, RBR-batch retrieves the complete transcript (e.g., transfer courses, completed courses, current courses, pre-registered courses, CLEP, credit-by-exam, work experience credit, and any other credits) of all active students. Additionally, all waivers and substitutions recorded electronically are retrieved. The college can also elect to retrieve records of inactive students for the past 1 year, 2 years, 5 years, etc.

Optimal Curriculum. There are instances in which a student's major includes multiple concentrations and the student's automated record does not list the concentration. A college may also allow students to opt for the current catalog. In each of these instances, RBR can run an algorithm to determine the optimal curriculum for the student, based on completed and current courses taken by the student. Optimal is defined as least credits to degree. The matching process can now begin.

Run the Matching Algorithm

Requirement IDs. Requirements have a set range of IDs as follows: Major and related requirements—1 to 49; general education requirements—51 to 79; minor requirements—80 to 99; and free electives—101 to 121. The matching algorithm is run sequentially on requirements 1 through 121, based on their assigned priority level (see below).

Requirement Priority. RBR-batch runs a priority/ID-based, iterative matching process for each requirement in the student's designated or optimal curriculum. The priority of a requirement is determined during development of the Requirements-Based Manifest (RBM) and not at run time. Priorities range from 1 to 21, with priorities of 1 running first and priorities of 21 running last. A requirement for which there is one and only one course always has a priority of one. Next, in developing the RBM, we evaluate whether any given course can satisfy more than one requirement. For example, if a curriculum has an upper-level economics elective and an upper-level business elective (which includes economic courses), the economics elective has a higher priority. Free or general electives always have the lowest priority of 21 and are run last.

Optimal Course Table. RBR-batch verifies for each requirement whether there is preferred course listed in the optimal course table. This table is populated during development of the RBM and not at run time. To illustrate, a business restricted requirement may allow for ECON 477 or MGMT 440. This requirement is more restricted, and therefore will run before an unrestricted upper-level economics elective. If a student has completed both ECON 477 and MGMT 440, RBR-batch will always map MGMT 440 to fulfill the business restricted requirement per the optimal course table, leaving ECON 477 available to fulfill the economics elective. The optimal course table also has a not-preferred course option. If the above-illustrated business restricted requirement allows ECON 477 and five other MGMT courses, we could easily specify Not ECON 477 as the preferred course in our optimal course table. RBR-batch would attempt to map courses other than ECON 477 to fulfill the business restricted requirement. If no match was found, RBR-batch would determine if the student had successfully completed ECON 477.

Optimal Course and Course Exception Procedures. In addition to a requirement's priority and the optimal course table, there are times that specialized procedures must be created and run to determine whether or not a requirement can be fulfilled. An example would be the transfer policy of Bowie State University (BSU), cited earlier. One of the stipulations in BSU's policy is that a student who transfers in 9 hours of humanities will be deemed to have met the university's humanities requirement, even if the major has designated a specific course, e.g., PHIL 103. In mapping courses to the humanities requirements, RBR-batch will first determine if a student has successfully completed PHIL 103. If not, for transfer students, RBR-batch will then see if the student has completed 9 hours of humanities. If so, RBR-batch will map one of the transfer humanities to fulfill the PHIL 103 requirement.

Course Precedence. RBR-batch maps courses to requirements based on the precedence of the course, including waivers of requirements. This precedence is as follows:
1. Waived requirement
2. Substituted course
3. Native course completed with grade of C, or better
4. Transfer course
5. Currently enrolled course
6. Pre-registered course
7. Native course with grade of D

For example, if an upper-level economics requirement was waived for a student, the CMM would show that requirement as waived, even if the student had successfully passed ECON 400. Similarly, if MGMT 333 has been substituted for the economics elective, MGMT 333 will be mapped to meet this requirement, even if the student had successfully passed ECON 400. In either case, the CMM will show ECON 400 as unused, and the records office has the option to remove the waiver or substitution during the initial creation of the CMM. Note that substituted courses fulfill both the requirement and hours of the requirement. A waived requirement waives the requirement only; the hours may be required in the form of a free elective.

Courses previously passed at the particular school with a grade of C or better have the third precedence, followed by transfer courses. Currently enrolled and pre-registered courses have a lower precedence in order to detect possible mis-registrations. For example, we look at the case of our transfer student, cited previously, who transferred in nine hours of humanities. Assume that this student was enrolled in PHIL 103. The CMM would show a transfer course (higher precedence) as meeting this requirement and PHIL 103 would be shown as not needed. In this case, the student may have the opportunity to drop PHIL 103 and register for an outstanding requirement.

Mapping Courses to Requirements—Grade Received and Course Hours. In line with the discussions above, we begin with requirements having a priority of one, and proceed sequentially based on the requirement's ID. Courses are mapped per course precedence. For priority one requirements (one and only one course to fulfill requirement), the course if taken is mapped, even if a passing grade was not received. The requirement status would be not passed. For all priorities above 1 (more than one course can fulfill requirement), the mapping process looks for an allowable course that satisfies the minimum grade required. If a course is found but the minimum grade was not earned, the course is not mapped and the requirement status is left blank.

In addition to a minimum grade, the RBM also specifies the number of hours for each requirement. In developing the RBM, we specify if a course must meet the minimum number of hours. An example would be BIOL 101, a 4-hour natural science course with a lab. Assume a student transfers in a 3-hour, non-lab course from a community college that was equated to BIOL 101. If the college accepts the transfer BIOL 101, then the BIOL 101 requirement will be met. However, the student will have a one-hour IOU (I owe the university). Essentially, in order to ensure the student has a minimum of 120 hours, a one-hour free elective is automatically added to the student's curriculum. Similarly, if a student transfers in a course that has more hours than specified by the requirement, the excess hours are automatically treated as student credit hours, which are applied to fulfill any outstanding free electives.

Note that the above processes create the initial Courses-Mapped Manifest. For example, we reference the case where a requirement is waived or has a substitution; then the student takes a course that meets the requirement. Or, a student enrolls in a course for a requirement that can be fulfilled by transfer course. After creation of the CMM and implementation of RBR, these types of situations will never arise. Quite simply, RBR will not allow the student to register for a requirement that has been fulfilled.

Requirements-Based Registration

RBR has many distinct tasks that mutually accomplish the goal of guaranteeing students only enroll in courses that meet a degree requirement. These key tasks are not all sequential, but are found throughout the process. Listed below are the vital tasks of RBR. Note that some of these tasks may be performed by conventional course registration systems. The tasks that are exclusive to RBR's requirement registration system are noted as such below.

1. Check Registration Flags [RBR exclusive for transfer and change-of-major flags]

2. Show Degree Progression parameters [RBR exclusive]

3. Show student their profile as listed in the System

4. Show Available Requirements for Student Selection [RBR exclusive]

5. Verify Requirement Selections [RBR exclusive]

6. Check for No Available Courses for Requirement [RBR exclusive]

7. Check for Singleton Available Course for Requirement [RBR exclusive]

8. Student Selection of one Course out of many that satisfy Requirement [RBR exclusive]

9. Course Check 1: Course existence

10. Course Check 2: Course credited

11. Course Check 3: Credits exceeded

12. Course Check 4: Fulfills requirement [RBR exclusive]

13. Course Check 5: Prerequisites\Corequisites

14. Course Check 6: Timing conflicts

15. Course Check 7: Course full

16. Course Check 8: Requirement priority [RBR exclusive]

17. Student Confirms Course Enrollment

18. NAD Registration [RBR exclusive]

19. Special Registration Exceptions [RBR exclusive—substitutions]

20. Course Withdrawals [RBR exclusive]

Check Registration Flags

Registration flags consist of an administrative flag and several special review flags. RBR checks the administrative flag to validate that the student has been admitted for the term and that the student is not on academic, financial, or judicial suspension or dismissal. Three special review flags are automatically set by RBR, as appropriate: first-time student, change of major student and transfer student. These flags must be turned off by the appropriate office and are designed to place accountability for proper advising and review of the student's courses from a previous major or school.

There are several other special review flags that RBR checks; however, these flags are set outside RBR, either student-by-student or by some batch process, e.g., setting the veteran flag to true for all veterans or the student accounts flag to true for all students with a balance over $25. Other flags include athlete, honors, international student, special admit, special program, student records, financial aid, academic standing, and academic department. For instance, athletes may be required to get a sign-off from the NCM compliance officer prior to registration. The athlete flag, controlled by the compliance officer, would enforce this requirement.

Show Degree Progression Parameters

RBR will show a student their Degree Progression parameters (if applicable). These parameters are: 1) minimum or maximum number of term hours, 2) maximum number of unrelated courses, and 3) maximum number of course withdrawals allowed. These parameters will help the system govern and enforce institutional policies surrounding enrollment hours.

Show Student Their Profile as Listed in the System

Once a student has been validated to register, the requirements based registration system will also show the student their academic profile as stored in the system. That is their curriculum, which includes their applicable major, minor, concentration, track, or special programs, the catalog they are listed under, and their standing (e.g.—junior, graduate student). This is the information used to determine their requirements and the courses they will be allowed to enroll in. If any of those factors are incorrect, the student MUST go to their academic department or registrar's office and have the information corrected in the system before registering. We recommend that students be able to see this information on-line readily at any point during the year.

Show Available Requirements for Student Selection

RBR takes all of the information compiled about the student in Step 0 and shows them their missing and available requirements. RBR will not show requirements that cannot be fulfilled by a student in the current period. For example, a student may have to fulfill their breadth requirements before they can fulfill their depth requirements. It is also important to note that RBR will not show the requirements that are currently being fulfilled by courses the student is taking in the present semester nor will it show requirements that the student has pre-registered for. Institutions can also mandate how many and which requirements are shown based on factors such as student classification level (e.g.—a freshman may not see junior or senior level requirements.)

Phase 2: Select Requirements and Generate Fulfillment Options (cont. FIG. 2)

The student begins this phase by reviewing their available requirements and selecting the requirements he/she would like to register for. Those selections are then verified by the system and if there are errors, the student must re-select requirements to register for. If there are no errors, RBR will get the list of courses that satisfy the requirements the student selected. If there is only one course that will satisfy a requirement, RBR will return the sections of that course. If there are multiple courses that will satisfy a requirement, RBR returns a list of those courses.

Verify Requirement Selections

The system must verify the requirements the student desires to register for. Recall that the degree progression parameters govern the minimum and maximum credits a student may take a semester. The system will enforce that the student enroll in at least the number of requirement hours as mandated by the degree progression requirements and no more than is allowed by institutional policy. For example, NC State University has a Progress Toward Degree policy that requires students to plan their course of study leading to graduation within a pre-specified number of years. If the student's individual plan specifies enrollment in no less than 15 hours per regular term, RBR will monitor the number of hours attempted. If this student attempts to register with less than 15 hours, RBR will take one of two actions as determined by each college: 1) simply warn the student that he/she did not register for the minimum of 15 hours, or 2) not allow the student to complete his/her registration.

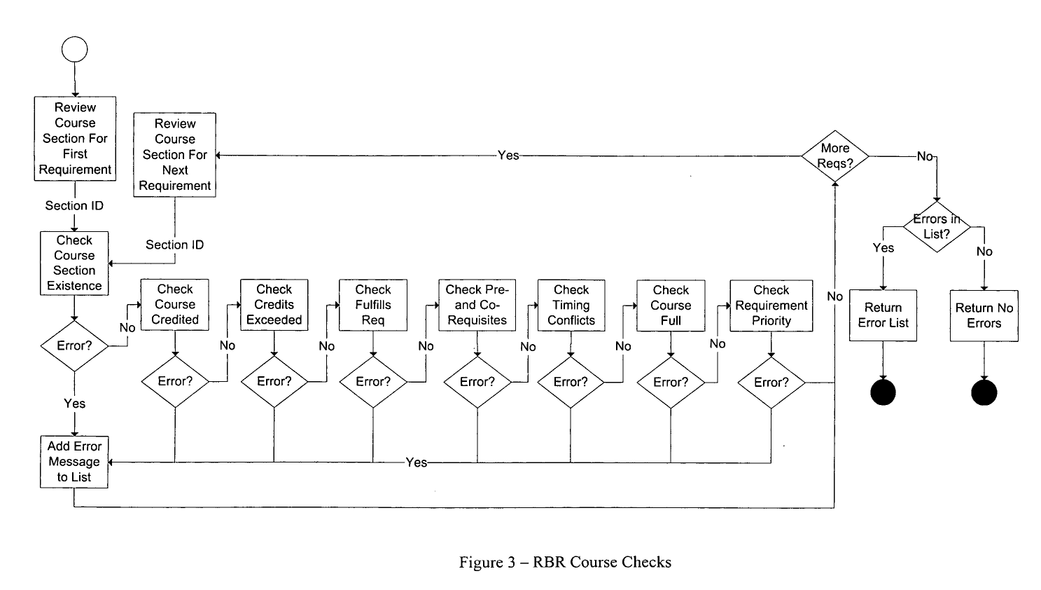

When the system verifies the student's requirement selections, the student is taken to the course page. This page allows the student to enroll in courses that will satisfy the requirements he/she selected on the previous page. RBR must make several real-time checks on the courses the student attempts to take to satisfy their requirements. The following real-time requirement—course mapping is done when a student selects a course to fulfill a requirement (see FIG. 3).

Check for No Available Courses for Requirement

RBR first checks to see if there are any courses being offered in the upcoming period, that the student is eligible for, that will satisfy the requirement. If there are no courses being offered in the upcoming period that will satisfy the requirement, the course box is populated with a message that notifies the student that no courses are available that satisfy the requirement. If there are no courses the student can take for a requirement, they will see that immediately and not waste time searching for courses they can take. This will remove some of the confusion from registration.

Check for Singleton Available Course for Requirement: Reference Applicable Charts

RBR then checks if there is only one eligible course being offered next semester that will satisfy the requirement. If this is the case, RBR will automatically populate the course box with the sections of the course that are being offered in the upcoming period. This is also done to save the student time and further ensure proper registration. If there is only one course the student can take for a requirement, they will see that immediately and not waste time searching for it. This is also aimed at removing some of the confusion from registration.

Phase 3: Select Course Sections (See FIG. 2)

In this phase, the student reviews the courses or sections that were returned from the system. If the student is viewing a list of courses, they will choose one course out of the list to enroll in. The system will then present the student with all sections for that course. The student will select one section to attempt enrollment in. If the system initially returned a list of sections (if there was only one course that met requirement), the student only needs to choose the section.

Student Selection of One Course Out of Many That Satisfy Requirement

If the above two scenarios are not applicable (i.e., there is more than one course that the student is eligible for can satisfy the requirement), then the student will have three options. The student may either 1) enter in a course subject (e.g.—ENGL for English) to get a listing of all courses that they are eligible for that will satisfy the requirement or 2) enter in the specific course number for the course that they would like to take to satisfy the requirement, or 3) simply press enter with no information, which will return a list of all courses they are eligible for that will satisfy the requirement. The third option could return an extremely long list of courses. For that reason RBR provides a mechanism by which a student can always see what courses are allowable for a requirement as listed in the RBM.

If the student enters a course subject, RBR will show the student all courses being offered within that subject in the upcoming period that satisfy the requirement, which they have not taken. The student can then select one of these courses to see all sections being offered for the course. Selecting a course from the returned list is identical to the student entering a specific course number. Selecting a course directly skips one step, but does not allow the student to see all courses that will satisfy the requirement under that subject.

If the student enters a specific course, the system will verify that 1) the course exists and is being currently offered, 2) the student has not already received credit for the course to fulfill the requirement, and 3) the course meets the requirement. If all of these tests are passed, the student will then be allowed to see all sections offered for the course.

If the student enters nothing, RBR will show the student all courses being offered in the upcoming period that satisfy the requirement, which they have not taken. The student can then select one of these courses to see all sections being offered for the course. Selecting a course from the returned list is identical to the student entering a specific course number. Selecting a course directly skips one step, but does not allow the student to see all courses that will satisfy the requirement. Once again, this option could return a long list of courses and could be disabled by institutions that want their students to be more directed in their course selections (i.e.—have an idea of what they want to take before they sit down at the computer).

Phase 4: Verify Selections and Complete Enrollment (cont. FIG. 2)

Once the student inputs or selects a course and clicks the add button, RBR will perform a series of additional checks to verify the aptness of the course (see FIG. 3). As a reminder, these tests are based on the individual student's profile that is registering. If there are errors in this verification, the student will return to the course section selection screen. If there are no errors the student will be successfully enrolled in courses that are guaranteed to count towards their degree.

We will now go into details about each course verification step. You will notice that some of the following checks have already been performed at some point during the course selection. However, it is important that RBR performs a complete final verification of course aptness prior to allowing a student to register for a requirement. This redundancy reinforces the safeguards of the system and increases the robustness of RBR.

Course Check 1: Course Existence

Is this course being offered in the upcoming semester? If this first test is in error, the student is presented with a message informing them that the course entered is not valid for the upcoming semester and they should refer to the View Course Information function on RBR to check the validity of courses/course numbers.

Course Check 2: Course Credited

Has the student received credit for this course? For example, do they have a transfer course that was equated to this course or was the course previously completed at their current school? If this third test is in error, the student is presented with a message informing them that they have already received credit for the course in which they are attempting to enroll. It will advise them to consult their advisor or the appropriate office on campus for further details. The student will not be registered in the course and will be returned to the previous screen.

Course Check 3: Credits Exceeded

Will enrolling the student in this course exceed the maximum credits they are allowed per semester? For example, students on academic probation may only be allowed to register for 13 hours. If this second test is in error, the student is presented with a message informing them that enrolling in this course would cause them to exceed their maximum allowed hours for a semester. The student will not be registered in the course and will be returned to the previous screen.

Course Check 4: Fulfills Requirement

Does this course satisfy the requirement the student is registering for? If this fourth test is in error, the student is presented with a message informing them that the course that they selected does not fulfill the requirement for which they are registering. They will then be presented with the option to view courses that satisfy the requirement or to cancel and return to the previous screen.

Course Check 5: Prerequisites\Corequisites

Is the student eligible to enroll in this course? This could be a series of factors such as required courses or classification. If this fifth test is in error due to the student failing to meet the prerequisites, they are presented with a message informing them that they have not taken the courses or do not have the classification necessary to enroll in this course. If the test indicates a corequisite, the remaining tests will be performed. If the course is then verified, the student will be presented with a message stating they are tentatively enrolled in this course pending registration into the corequiste course. It will then ask the student if they would like to register for the corequisite now or be withdrawn from the tentative course.

Course Check 6: Timing Conflicts

Do schedule conflicts exist with this course and a course in which the student has already pre-registered? If this sixth test is in error, the student is presented with a message informing them that enrolling in this course will create a timing conflict in their schedule. They are advised that they may drop the course creating the conflict and attempt registration for this course again. The student will not be registered in the course and will be returned to the previous screen.

Course Check 7: Course Full

Is the course currently at capacity? If this seventh test is in error, the student is presented with a message informing them that the course is full. They are advised that they may add themselves to the waiting list (if that option is offered by the university). The student will not be registered in the course and will be returned to the previous screen.

Course Check 8: Requirement Priority

Does this course fulfill a requirement that supersedes the requirement under which the student is registering? If this eighth test is in error, the student is presented with a message informing them that this course fulfills a requirement that is more restrictive (and therefore has a higher priority) than the requirement they are registering for. They are told that this course will be used towards the higher priority requirement if they enroll. For instance, if a student registers for a free elective with an ECON class that fulfills an unsatisfied core elective, the course will be used toward the core elective requirement.

Sequence of Course Checks

If we think in terms of a conventional registration system, it may appear that having “Timing Conflicts” and “Course Full” as the sixth and seventh of eight checks, respectively, are misplaced. However, in a requirements based registration system, this sequence is not only appropriate, but extremely beneficial to the student. At every step, RBR attempts to provide the student with the information needed to make informed and suitable decisions. Consider the following:

1. Course existence—If the course does not exist, none of the other checks apply. For instance a course that does not exist cannot make a student exceed their maximum number of credits.

2. Course credited—If the student has received credit for the course they are attempting to enroll in, it is irrelevant if the course meets a requirement or not, because RBR has already assigned that course to a requirement (if possible).

3. Credits exceeded—If enrolling in this course causing a student to go beyond their maximum hours, it is irrelevant if the course meets a requirement or has a timing conflict.

4. Fulfills requirement—RBR, unlike other course registration systems, is primarily concerned with students enrolling in courses that meet degree requirements. For example, it will do the student little good to tell them a course section is full if the course does not meet a requirement. In that situation, they would waste time looking for another section that fit into their schedule or readjust their current schedule so they can sign up for the course section in question only to be told later that the course does not meet a requirement.

5. Prerequisites/Corequisites—Now that the course does indeed satisfy a requirement, we can verify that the student has any pre- or co-requisites necessary to enroll in the course. If they do not, it is irrelevant if the course section is full or presents a timing conflict.

6. Timing conflict—The impeding factor in this check is based purely on the section. Another section of the course that fits into the student's schedule will pass the check. This check is placed before course full, because in that situation the student could waitlist for the course. It is possibly harmful to let the student waitlist for a course section that will conflict with their existing schedule.

7. Course Full—Again, a failure on this check pertains solely to the section the student is registering for. A student can waitlist if the institution provides that option or simply select another section of the same course if one is available that fits into their schedule.

8. Requirement Priority—This is the last check, because it in no way will prevent a student from enrolling in a course once the previous seven checks have been passed. It is designed to make sure the course is being used for the most restrictive requirement the student has not yet fulfilled.

Student Confirms Course Enrollment

Once these eight checks have been successfully verified, the student will be presented with two options. The student can confirm the course add or cancel the registration. These steps will ensure correct registration for students and help ensure that students matriculate through their higher education experience without being held back by unnecessary or unwarranted courses. With RBR, the contract between the student and school will be enforced.

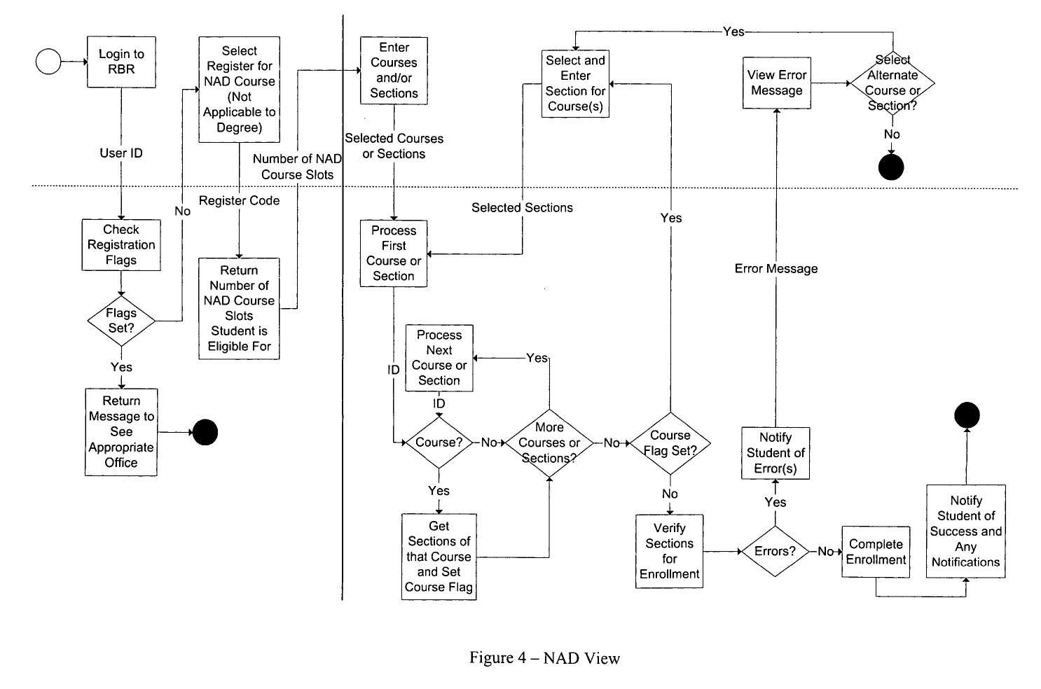

FIG. 4

NAD Registration

An institution can allow students to enroll in courses Not-Applicable to their Degree. We refer to these as NAD courses. Students often have interests outside their major and in an effort to cultivate more well-rounded students, an institution may decide to allow its students to enroll in a limited number of courses outside their degree. An institution can vary the number of NAD courses they allow their students to take based on any factor within their student record. This includes their classification, GPA, or major. As you will notice in FIG. 4, NAD course selection is a much simpler process than RBR.

When a student logs into RBR, the system first checks the registration flags and retrieves the student's record. If the university policy allows the student to take NAD courses, the student will have the option of selecting Register for NAD Course. The student will be warned that any course they enroll in will not count towards their degree. If they proceed the system will return the number of NAD courses university policy allows that student to take. For example, if students are allowed to take 3 NAD courses in their college career and the student has already taken one NAD course, the system will return two NAD course slots. The system will also collect information from the student on whether they are taking NAD courses to be full-time or for personal enrichment. In this way the university can collect information on the unavailability of courses and how that affects increased TCD.

The student will then enter the course or specific section they want to take for each NAD course they can and wish to register for. If the student enters a course, the system will return the list of sections for that course. The student will then select a section and submit it for registration. If the student enters a section, the system automatically processes it for registration.

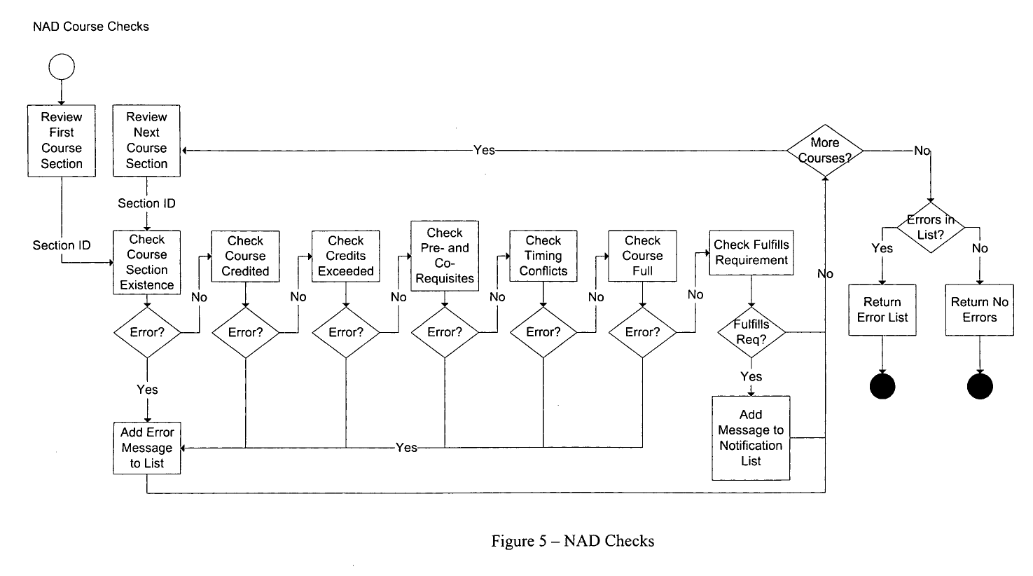

The NAD process also performs several checks on the courses a student submits, however, it must be noted that none of these checks, except check 7, is based on the student's degree requirements. Like conventional registration systems, these checks are based solely on the course. The following checks are performed during a NAD course registrations, as illustrated in FIG. 5:

1. Course Check 1: Course existence

2. Course Check 2: Course credited

3. Course Check 3: Credits exceeded

4. Course Check 4: Prerequisites\Corequisites

5. Course Check 5: Timing conflicts

6. Course Check 6: Course full

7. Course Check 7: Fulfills a Requirement

These course checks are identical to their counterparts discussed above. However, Course Check 7 will not prevent a student from enrolling in the course. If the course actually fulfills a requirement, the student will be notified and the course will be used to fulfill the outstanding degree requirement.

Special Registration Exceptions

Since RBR does not allow students to register for 1) a requirement that has been fulfilled or 2) a course that does not meet a requirement (per the requirements based manifest), students will be required to obtain exceptions through the designated office, e.g., their department, Dean's office, or the registrar's office. There are two typical situations:

1. Repeating passed course to improve grade. Institutions have varying policies on repeat courses. Some institutions will accept the highest grade, some will take the last grade received, and others will take the average grade received. Studies have shown that students do not on average receive higher grades in courses they repeat and as such, in the preferred embodiment RBR does not allow students the unrestricted option to repeat courses which have already met a requirement. However, if an institution chooses to allow students to repeat these courses, RBR can implement that policy. The recommended solution is for the institution to require the student to register for these courses through the office designated by the college. In this way the student can receive counseling prior to repeating a course which has already met a requirement; and,

2. Current Course to be Substituted. Course substitutions are common and the increasingly popular four-year graduation guarantee stipulates that if a needed course is not available, the college will make a good faith effort to offer an alternate course to meet the requirement. Historically, course substitutions have at times been too informal, i.e., oral, a note in student's folder, etc. RBR requires substitutions to be formal and official. The only means by which a student can be registered for a “to-be-substituted” course is that the designated office overrides the RBR verifications. RBR instantly maps the substitute course to fulfill the applicable requirement (if successfully completed) and maintains a permanent audit of the date, authorizing office, individual, and reason for substitution.

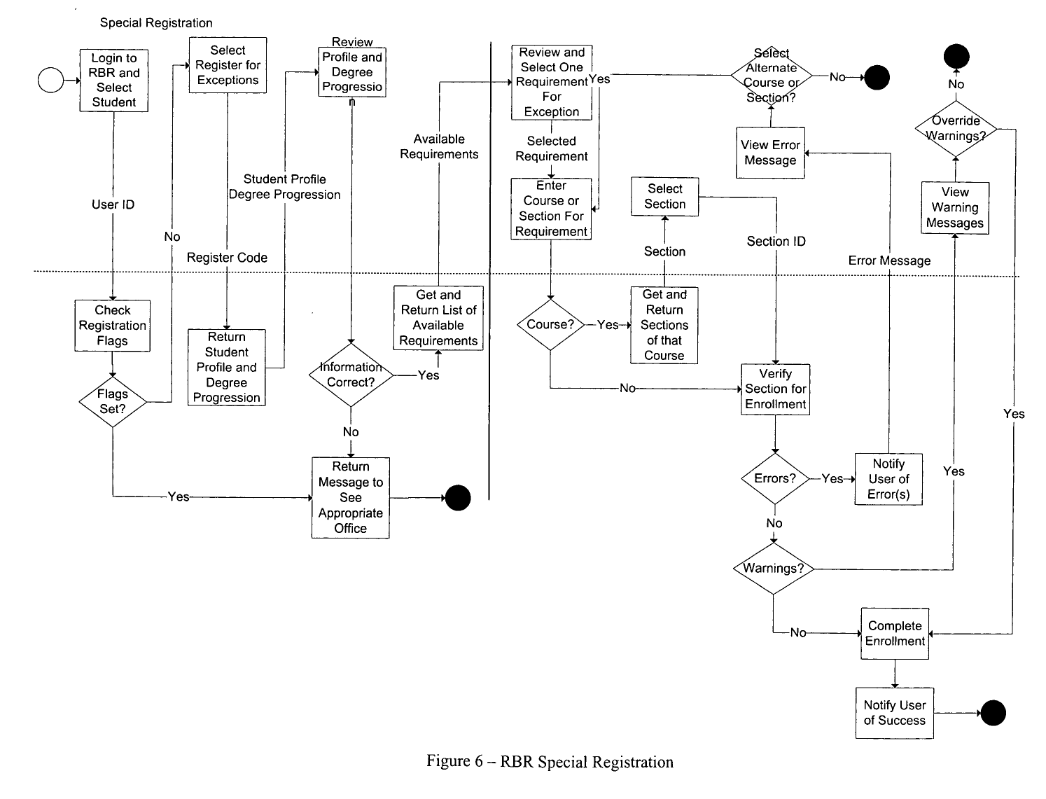

The process that the designated office must go through to register a student for a special exception in RBR is somewhat similar to the student's process (see FIG. 6). The staff member will log into the RBR system and select the student they wish to register for a requirement. The system still checks the registration flag of that student prior to allowing any registration. If there is an error, the offending registration flag must be turned off before the student can register. For example, a student's department should not be able to register a student if the Student Accounts Office has set a flag indicating the student has not paid their tuition. The staff member will then select that they wish to register the student with a special exception. The system then returns the student's profile and degree progression information. This must be verified with the student and is also provided to give the staff member direct knowledge of the student's academic status. If this information is correct, the system will return a list of available requirements for the student.

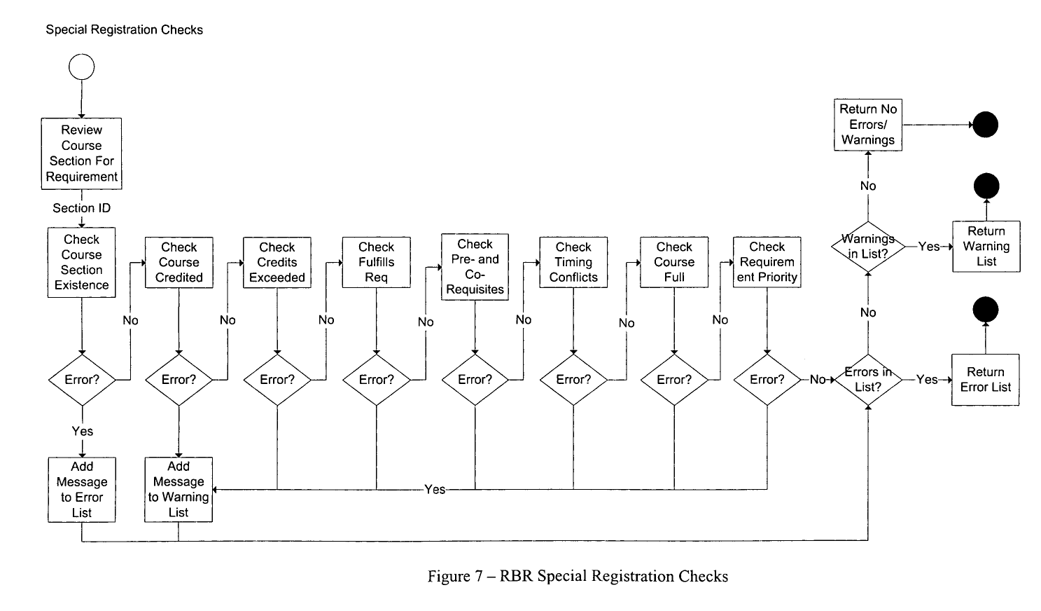

The staff member will then be able to select one requirement for a registration exception. To select more, they must repeat the entire process from this point. The staff will now enter a course or specific section for the requirement they selected. Unlike student RBR, the system does not return a list of courses that satisfy the requirement per the RBM. This is due to the registration being for an exception that is not listed in the RBM. If the staff member enters a course, the system will return the sections of the course for selection. If the staff member enters a specific section, the RBR verification process will begin (see FIG. 7).

The checks in RBR special registration are identical to those in standard RBR. The difference is, only the first check of course existence produces an error. If any other check fails, it provides a warning that can be overridden by the staff member. The first check cannot be overridden, because the staff member must choose a course that exists. If the verification process returns a list of warnings, the staff member must decide to override each returned warning and based on institutional preference, may be required to enter the reason for each override. This places accountability on the office that provides the substitution and documents the student's record for future reference.

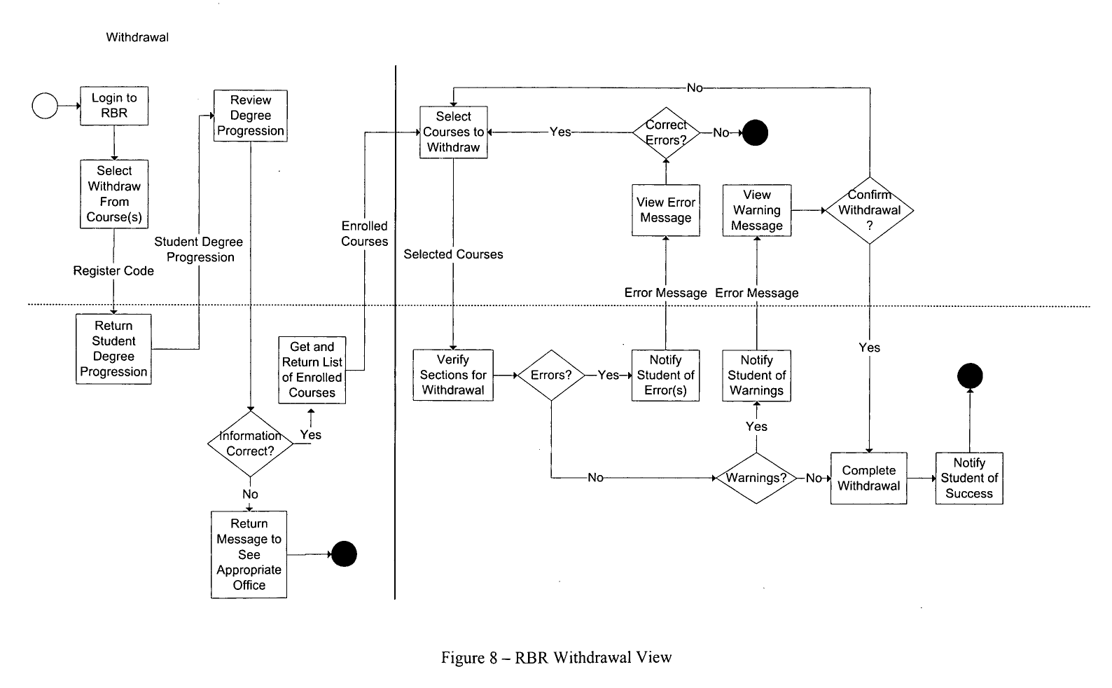

FIG. 8

Course Withdrawals

RBR also provides special verifications when a student chooses to withdraw from a course. The student must first login to the system and select the Withdraw from Course option. The system then retrieves the student's degree progression information and returns it to the student. This is to remind the student of their university requirements in terms of enrollment hours. Once the student verifies their degree progression requirements, the system will return the list of courses they have enrolled in.

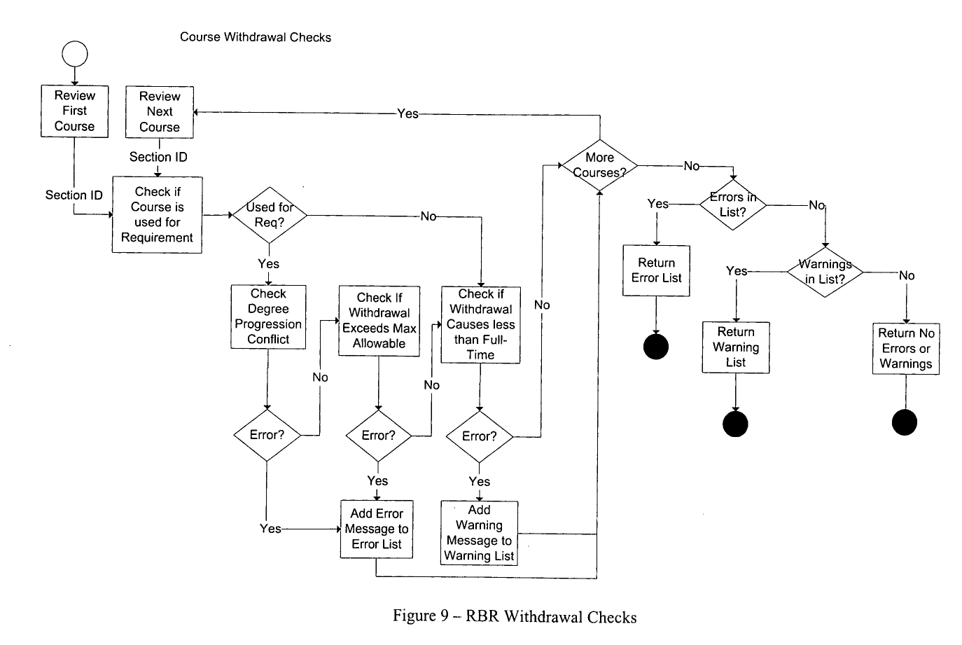

The student will select the courses he/she wishes to withdraw from. RBR then performs a series of checks to ensure the student can withdraw (see FIG. 9). The checks are as follows:

1. Check 1—Degree Progression Conflict

2. Check 2—Withdrawal Exceeds Max Allowable

3. Check 3—Withdrawal Reduces Student Below Full-Time

By default, the first two checks produce an error, while the last check only gives the student a warning. This can be adjusted based on university preference.

RBR first checks to see if the course was being used towards a requirement. If it is not, checks 1 and 2 are skipped. The degree progression requirements in RBR govern enrollment of courses that fulfill degree requirements. It is unaffected if a student withdraws from a course that was not being used towards their degree. The Withdrawal Exceeds Max Allowable check is based off of research that states students who withdraw from a number of courses usually take longer to complete their degree. However, if the student is withdrawing from a course that does not meet a requirement, that action alone can not extend their time-to-degree. The Withdrawal Reduces Student Below Full-Time is still run, because students always need to be notified of actions that can affect their financial aid or standing at the institution.

Check 1—Degree Progression Conflict

If the course the student wishes to withdraw from is being used towards a requirement, RBR checks for degree progression conflicts. That is, is withdrawing from this course going to cause the student to fall below what is required by their program or university policy. If this is the case, the system logs an error to return to the user.

Check 2—Withdrawal Exceeds Max Allowable

If the first check does not produce an error, RBR checks to see if the student has already reached their course withdraw limit based on institution policy. If this is the case, the system logs an error and the student is not allowed to withdraw.

Check 3—Withdrawal Reduces Student Below Full-Time

This check causes a warning if the student's course withdraw will change their status as a full-time student at the institution. This action will most likely also affect the student's financial aid. By notifying the student of this prior to their withdrawal, the university discourages withdrawals and places accountability directly on the student.

Once these checks are passed, the student is allowed to withdraw from the course.

RBR provides institutions with a direct, results oriented implementation mechanism to enact and enforce policies to reduce time-to/credits-to-degree. It gives advisors more time to focus on the discretionary and personal aspects of advising with their advisees. Students are given a system that eliminates mis-registration and ensures they are making continuous progress towards their degree. State and federal governments are ensured that taxpayers' dollars are going towards courses leading to degrees. RBR fulfills a critical need in higher education that positively affects all interested parties.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. An automated requirements based registration system, the registration system having multiple software modules with each module containing routines and sub-routines designed to be executed on one or more computers, the registration system being adapted for use by a degree granting institution for decreasing time-to-degree and credits-to-degree by students of the institution by optimizing a registration process that is performed by the students of the institution, the system comprising:
a profile module that builds a profile for each student, each profile containing academic and non-academic information regarding an associated student;
a registration module, wherein the registration module is used to gather and verify information about the students' profiles, to show the students their unique outstanding requirements for degree progression and generate fulfillment options for requirements the students should complete, the registration module also being capable of verifying student course section selections, notifying the students of any errors, and completing the registration process;
a non-degree module, wherein the non-degree module is in communication with the registration module and provides information to the registration module and to the students on courses that do not count toward a desired degree, the non-degree module allowing the students to register for a limited number of courses, to achieve full-time status and for personal enrichment, which are not required by the students' desired degree;
a special registration module, wherein the special registration module is in communication with the registration module, can only be accessed by a staff member of the institution and allows the staff member to register the students for courses that otherwise would not be allowed by the requirements based registration system;
a withdrawal module, wherein the withdrawal module is in communication with the registration module and provides information to the registration module and the students regarding courses from which the students have withdrawn and are considering withdrawing;
an interface module, wherein the interface module is in communication with the registration module and provides the students with a user interface that enables the students to perform the registration process in a manner that ensures each students' desired degree will be achieved in a shortest amount of time and by taking a smallest number of courses.

2. The system of claim 1, wherein registration module comprises:
administration flags that are used to indicate that the students have been admitted for an upcoming term and are not on academic suspension nor financial suspension;
multiple special flags that are used to indicate first time students, change of major students and transfer students; and,
a fulfillment options module, the fulfillment options module having information on a requirements for each degree that is offered by the institution, wherein the requirements' include a list of all courses that must be taken for each degree and a list of courses that may be taken for each degree, wherein the options module is capable of generating one or more potential course-loads for the students that ensures each students' desired degree will be achieved in the shortest amount of time and by taking the smallest number of courses.

3. The system of claim 1, wherein the registration module further comprises:
a course sections module, that checks to make sure specific sections of courses that the students attempt to register for are actually available to the students; and,
a verification module, that provides verification to the students at an end of the registration process regarding which courses the students have successfully registered for and which courses failed verification.

4. The system of claim 1, wherein the registration module further comprises:
a course check module that checks for an existence of desired course sections, duplication of courses, credits exceeded, fulfillment of degree requirements, pre-requisite and co-requisite fulfillment, timing conflicts, availability of courses, and degree requirement priority.

5. The system of claim 1, wherein the non-degree module further comprises:
one or more registration flags that are used to allow students to register for one or more non-degree courses;
a requirement for the students to enter their reason for enrolling in a non-degree course;
an ability to display a warning to the students indicating that all courses registered for, within the non-degree module, will not count toward their desired degree;
an ability to display a notification to students that a course registered for within the non-degree module in fact can be used to fulfill a degree requirement and will be used to satisfy the degree requirement; and,
an ability to display to the students a remaining number of non-degree fulfilling courses that the students are allowed to take, in accordance with a policy of the institution.

6. The system of claim 5, wherein the non-degree module further comprises a
course check module that checks for an existence of desired non-degree fulfilling course sections, duplication of courses, credits exceeded, pre-requisite and co-requisite fulfillment, timing conflicts, availability of courses, and possible requirement fulfillment.

7. The system of claim 1, wherein the special registration module further comprises a course check module that checks for an existence of desired course sections, duplication of courses, credits exceeded, fulfillment of degree requirement, pre-requisite and co-requisite fulfillment, timing conflicts, availability of courses, degree requirement priority, and verifies registration.

8. The system of claim 1, wherein the withdrawal module retrieves and displays the students' degree progression information, presents all currently enrolled in courses to the students for selection of courses from which the students wish to withdraw, and runs a series of checks that result in the students being warned of any potential changes in the students' status as a result of a desired withdrawal.

9. The system of claim 8, wherein the series of checks run by the withdrawal module include checking for:
a degree progression conflict, which indicates if a withdrawal may require the student to attend the institution longer than usual in order to obtain their desired degree;
exceeded maximum allowable withdrawals, which indicates whether or not the students have, or are about to, exceed the institutions maximum number of courses that students may withdraw from; and,
dropping below full-time status, which indicates to the students if the desired withdrawal will result in the students dropping below the institutions minimum number of credit hours for full-time status.

10. A method of registering for courses at a degree granting institution using an automated requirements based registration system that includes multiple software modules with each module containing routines and sub-routines designed to be executed on one or more computers, the method having the ability to decrease time-to-degree and credits-to-degree by students of the institution by optimizing a registration process that is performed by the students of the institution, the method comprising the steps of:
gathering information on the students, each students' desired degree, and all courses offered by the institution;
checking administration flags to ensure that the students have been admitted for an upcoming term and have not been suspended from the institution;
checking special flags, which are used to indicate first-time, change of major and transfer students;
displaying degree progression information to the student, so the students are made aware of: a minimum number of term credit hours required for full-time status; a maximum allowable number of unrelated courses that may be taken without negatively impacting a desired time-to-degree and credit-to-degree; and, a maximum number of course withdrawals allowed by the institution;
showing the students their academic profile as stored in the system, each student's academic profile having the ability to include a major, a minor, an area of concentration, a curriculum that includes suggested courses for the major, the minor and the area of concentration, the student's class standing, and a course catalog of the institution;
presenting all available degree requirements, that the students have not yet satisfied, to the students;
having the students select requirements that they would like to register for;
generating fulfillment options for the requirements the student selected;
having the students select courses from the set of fulfillment options;
verifying that the selected courses fulfill the students' desired degree;
displaying available sections for courses that fulfill the students' desired degree;
allowing the students to register for courses that fulfill the students' desired degree; and,
indicating to the students whether or not the courses that they registered for represent a course-load that is within parameters set by the institution.

11. The method of claim 10, further comprising the steps of:
indicating to the students when no courses are being offered by the institution that fulfill the students' desired degree; and,
notifying the students when only one course is being offered by the institution that fulfills the students' desired degree.

12. The method of claim 10, further comprising the steps of:
showing the students all requirements that they still need to take in order to achieve their desired degree; and,
displaying to the students all requirements that are being offered in the next term that the students still need to take in order to achieve their desired degree.

13. The method of claim 10, wherein the step of allowing the students to register for courses that fulfill the students' desired degree, further comprises:
verifying that the courses exist and are being offered by the institution; and,
checking to make sure the students have not already taken the courses.

14. The method of claim 10, further comprising the step of:
providing error messages to the students when an error occurs, the error messages telling the students a nature of the error and possible solutions for correcting the error.

15. The method of claim 10, wherein at least one of the software modules includes multiple administrative flags for indicating the students have been admitted to the institution for an upcoming term and have not been suspended, and also includes multiple special flags for indicating first time students, change of major students and transfer students.

16. The method of claim 10, wherein at least one of the software modules includes a course check routine that checks for an existence of desired course sections, duplication of courses, credits exceeded, fulfillment of degree requirements, pre-requisite and co-requisite fulfillment, timing conflicts, availability of courses, and degree requirement priority.

17. The method of claim 10, wherein one of the software modules is a non-degree module that handles registration of the students for courses that do not count toward their desired degree, the non-degree module comprising:
one or more registration flags, that are used to allow students to register for one or more non-degree courses;
an ability to display a warning to the students indicating that all courses registered for, within the non-degree module, will not count toward their desired degree; and,
an ability to display a notification to students that a course registered for within the non-degree module in fact can be used to fulfill a degree requirement and will be used to satisfy the degree requirement; and,
an ability to display to the students a remaining number of non-degree fulfilling courses that the students is allowed to take, in accordance with a policy of the institution.

18. The method of claim 10, wherein one of the software modules is a special registration module that can only be accessed by a staff member of the institution and allows the staff member to register the students for courses that otherwise would not be allowed by the requirements based registration system, the special registration module comprising:
a course check module that checks for an existence of desired course sections, duplication of courses, credits exceeded, fulfillment of degree requirement, pre-requisite and co-requisite fulfillment, timing conflicts, availability of courses, degree requirement priority, and verifies registration.

19. The method of claim 10, wherein one of the software modules is a withdrawal module that retrieves and displays the students' degree progression information, presents all currently enrolled in courses to the students for selection of courses from which the students wish to withdraw, and runs a series of checks that result in the students being warned of any potential changes in the students' status as a result of a desired withdrawal.

20. The method of claim 19, wherein the series of checks run by the withdrawal module include checking for:
a degree progression conflict, which indicates if a withdrawal may require the students to attend the institution longer that usual in order to obtain their desired degree;
exceeded maximum allowable withdrawals, which indicates whether or not the students have, or are about to, exceed the institutions maximum number of courses that students may withdraw from; and,
dropping below full-time status, which indicates to the students if the desired withdrawal will result in the students dropping below the institutions minimum number of credit hours for full-time status.
